(19) United States
(12) Patent Application Publication
(10) Pub. No.: US 2013/0282294 A1
(43) Pub. Date: Oct. 24, 2013

(54) Methods and Systems for Processing Data

(71) Applicant: Sean Moore, Oviedo, FL (US)

(72) Inventor: Sean Moore, Oviedo, FL (US)

(21) Appl. No.: 13/797,927

(22) Filed: Mar. 12, 2013

Related U.S. Application Data
(60) Provisional application No. 61/636,048, filed on Apr. 20, 2012.

(51) Int. Cl. G06F 19/00

(52) U.S. Cl. CPC G06F 19/70
USPC 702/19; 702/22

(57) ABSTRACT

The present invention is directed to methods and systems for applications relating to correction of numerical data resulting from dynamic changes to a true value. Such methods and systems may be used in accurate and unbiased quantitative polymerase chain reaction measurement.

### CROSS-REFERENCE TO RELATED APPLICATION

The present application claims the priority of and the benefit of the filing date of U.S. Provisional Patent Application No. 61/636,048 filed Apr. 20, 2012, which is herein incorporated by reference in its entirety.

### BACKGROUND

The processing of numerical data occurs in many applications of data gathering in clinical, research, and everyday situations. When this data is processed, either by repeated measurements of a value from an analog or digital system, or by the passage of data through a non-ideal system, the data can become corrupted by the addition or subtraction of a relatively constant value each time a processing event occurs. This can lead to signal loss or gain as a function of the number of measurements. The overall conclusion or intermediate data may then be inaccurate, especially in determining the actual events that are being measured or the initial quantity at the beginning or at any intermediate points of a reaction. An example of such data processing and the inaccuracy of the currently used data processing is seen in quantitative polymerase chain reactions

Quantitative polymerase chain reactions (qPCR) are used to monitor relative changes in very small amounts of DNA. One drawback to qPCR is reproducibility: measuring the same sample multiple times can yield data that is so noisy that relevant differences can be dismissed. Numerous analytical methods have been employed that can extract the relative template abundance between samples. However, each method is sensitive to baseline assignment and to the unique shape profiles of individual reactions, which gives rise to increased variance stemming from the analytical procedure itself.

Since its inception, the polymerase chain reaction (PCR) has markedly advanced molecular biology, perhaps more than any other single technique (Saiki et al., 1985; Mullis et al., 1986; Mullis et al., 1987). One common application of PCR is to amplify specific DNA targets of interest from complex mixtures so that a determination of the initial abundance can be made. Quantitative PCR is implemented by monitoring the increase in dsDNA product as a function of the number of thermal cycles and has evolved into a large industry that focuses on monitoring and analyzing product accumulation in real-time, usually with an increase in a fluorescent signal (Higuchi et al., 1993). Commonly employed quantification methods include either fitting sigmoidal functions to the raw data or fitting linear functions to log-transformed data. The latter is considered more accurate because it displays less variance and gives reproducible estimates of the reaction efficiencies (Peccoud et al., 1996; Liu et al., 2002; Ramakers et al., 2003; Rutledge 2004; Spiess et al., 2008; Ruijter et al., 2009; Rutledge et al., 2010; Page et al., 2011). What is lacking in the field is a mathematical model that accurately predicts the accumulation of product throughout an entire reaction (Boggy et al., 2010). With a complete model, an entire qPCR data set can be used for template quantification and the influences of baseline adjustment and signal quality can be directly assessed by comparing real and synthetic data.

The polymerase chain reaction (PCR) is, in theory, an exponential amplification of template DNA because during each thermal cycle a template becomes two more (Mullis et al., 1986). With this premise in mind, the accumulation of product can be modeled either exponentially (predicting raw data) or through a log transform, which linearizes exponential data (Ruijter et al., 2009; Rutledge et al., 2010; Boggy et al., 2010; Bustin et al., 2009). A sticking point during these analyses is that the true reaction efficiency, which is the efficiency of converting a template into two products during each cycle, remains elusive because much of the efficient amplification occurs before the observable data rises above background (Page et al., 2011). This problem can be partially alleviated by employing methods that report the accumulation of product at earlier cycles, before the reaction efficiency has substantially waned (Holland et al., 1991). Unfortunately, increasing signal sensitivity with hyper-sensitive reporters comes at a substantial cost that frequently outweighs its advantages over less expensive methods.

What is needed are methods and systems that do not incorporate inaccurate constant values each time a processing event for data occurs. What is needed are methods and systems for determining template abundance with high precision, even when the data contains baseline and signal loss defects. Methods and systems that reduce the time and cost associated with qPCR would be desired and would be applicable in a variety of academic, clinical, and biotechnological settings.

### SUMMARY

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1(A-D) provides graphs that show a comparison of PCR equations. In FIG. 1(A), product formation (green circles) is modeled to accumulate with a perfect, constant efficiency of 100% (blue diamonds) using Equation (4). The simulated data was fit using non-linear regression using the same function (black line). In FIG. 1(B), simulated data of a purely reagent-limited reaction is shown using Equation (5) with a maximum product yield of 5×10⁶ (also fit to its function). FIG. 1(C) shows simulated data using the PCR Equation (6) with a max value of 5×10⁶ and a K_{d} value of 5×10⁵. The efficiency terms at each cycle were extracted and plotted as blue diamonds. FIG. 1(D) shows examples of real qPCR data fitted to Equation (6) from amplifications using cDNA libraries generated from total E. coli RNA as templates. The resulting fitting values were: rpsO, max=25.148, K_{d}=1.6798, R²=0.99996; gapA, max=19.56, K_{d}=1.5753, R²=0.99998; lacZ, max=16.29, K_{d}=1.141, R²=0.99996.

FIG. 2(A-C) provides a graph that shows simulated PCR and cycle threshold analysis. In FIG. 2(A), PCR product formation was modeled according to Equation (6) with max=5×10⁶ and K_{d}=5×10⁵. Four data points are highlighted that depict the region when the signal reached 1% of the final maximum observed. The data was transformed into log₂ and the same 4 points were fit using linear regression. The slope and intercept from that fit were used to construct a straight line that was overlaid onto the log₂ plot (FIG. 2(B), diamonds). Note that the line does not predict the true progression of product at earlier cycles. Also, the earlier a reliable signal can be observed, the more accurate the estimation of the trend. FIG. 2(C) shows the derivative of the log 2 data. A value of 1 means that the efficiency was 100% and the product doubled during that cycle. The region fitted for the cycle threshold analysis is marked in red and each value is lower than all preceding cycles.

FIG. 3(A-B) shows graphs of two-step quantification. The PCR Equation (6) is fitted to experimental data with weighting for stronger signals by floating the values max and K_{d}. These values are then used to generate simulated data and a seed amount is computed that best superimposes the simulated data onto the experimental data. The relative values of seed correspond to the relative amounts of template DNA at that cycle. FIG. 3(A) shows fit to obtain profile and FIG. 3(B) shows fit to obtain abundance.

FIG. 4(A-B) provides graphs that show regression to determine relative abundance. FIG. 4(A) shows 6 independently-mixed qPCR samples that amplified cDNA from the ompT gene were fitted to PCR Equation (6) to obtain max and K_{d} values. These were then used in a spreadsheet to model synthetic data. The hypothetical DNA amount present as seeding doses in cycles 4, 9, 14, and 19 (arrows) were computationally floated to minimize the differences between the simulated and real data in cycles 5 plus through 20 plus, respectively. The seed amounts present in cycles 4 and 19 differed by more than 3×10⁴. FIG. 4(B) shows the calculated seed amounts are plotted as fractions of the mean (straight lines) with dotted lines connecting the data from two outliers to highlight the small variance when different cycles were used in the regressions of the same sample.

FIG. 5(A-B) provides graphs that show regression analysis is insensitive to reaction efficiency and template abundance. FIG. 5(A) shows six qPCR mixtures targeting the E. coli gapA cDNA contained either 0, 0.01, 0.03, 0.12, 0.5, or 2 units of thermostable inorganic pyrophosphatase (New England Biolabs) added as 1 μL of a 20 μL reaction. The remaining volume was matched using the same storage buffer lacking enzyme. Fitting of the resulting amplification profiles with the PCR Equation (6) (lines) yielded max and K_{d} values that were used to calculate relative abundance in cycle 14 (arrow). The same data was also analyzed using the Cₜ method for comparison (inset). FIG. 5(B) shows a series of cDNA libraries were used as templates for qPCR that had been generated from an experiment in which the gapA mRNA levels changed drastically over time (series A and B). For clarity, only the data fitting curves are shown for series B in which the template abundance changed more than 20-fold. Both regression (circles) and Cₜ (squares) analyses were performed on the same data and the relative abundance plotted as a function of time (inset). Note that the resulting values described the same relative changes and trends, but that the regression method yielded smoother data.

FIG. 6(A-D) provides graphs that show baseline errors and their influence during data analysis. FIG. 6(A) shows the log₂ transforms of simulated perfect qPCR data (circles) that were altered by adding either a small amount to each point (0.1% of the maximum signal, “too high”, triangles) or that were raised above the baseline slightly and then lost signal every time a measurement was made (“too low”, squares). Note that the sample undergoing signal loss loses log transform data when the raw values become negative. FIG. 6(B) shows the derivative of the log data is plotted to illustrate that these small baseline errors dramatically influence the apparent reaction efficiencies. FIG. 6(C) and FIG. 6(D) show experimental data is analyzed before and after a correction for signal loss. Unlike the uncorrected data, the log transform of the adjusted data exhibits a nearly-linear trend as the raw data leaves the baseline. The derivative indicates that the apparent efficiencies of the corrected data trend towards the theoretical maximum, unlike the uncorrected data.

FIG. 7(A-B) provides graphs that identify and correct signal loss. FIG. 7(A) shows simulated data of a perfect reaction was modified such that 1% of the fluorescence signal was lost during each measurement (squares). The damaged data was then corrected using Equation (8) (circles). Fits of the PCR Equation (6) yielded max and K_{d} values from the corrected data that were identical to those used to generate the raw data (50 and 0.5 respectively). The max and K_{d} values of the damaged data were each reduced (26.445 and 0.45519 respectively). The residuals of the fit to the damaged data are shown below. FIG. 7(B) shows experimental data before (circles) and after (triangles) manual correction for a linear sloping baseline. The inset shows the baseline region on a different scale to highlight the small signal loss in the raw data. The max and K_{d} values for the uncorrected data were 25.419 and 1.2116 with an R² of 0.99905. These values were 25.675, 1.2114, and 0.99918 for the corrected data. The residuals for the uncorrected (squares) and corrected data (circles) are displayed below. These residuals are typical of the fits to real data and indicate that either the model is incomplete or the raw data are not perfect despite attempted corrections.

FIG. 8 shows a block diagram of an exemplary system of the present disclosure.

FIG. 9 shows an exemplary method of the present disclosure.

### DETAILED DESCRIPTION

The present invention comprises methods and systems for the correction for step-wise signal distortions in numerical data containing dynamic changes to the true value. The methods and systems result in corrected data that is more precise and allows for more accurate quantification and reproduction of the original signal.

Signal changes occur in many systems, such as from unfaithful reproduction, the introduction of noise, or the unintentional addition or subtraction of data. When data is either lost or subtracted from the true signal, it can be difficult to recognize that the data has been corrupted unless a suitable reference signal can be used for comparison. The methods and systems of the present invention provide correction of data stemming from a consistent loss or gain in signal strength and restoration of the original signal. Subsequent analyses or implementation of the corrected data are more accurate.

The present invention is useful for correction of data in, but not limited to, growth analysis, communication signals, audio compression and decompression, stored or retrieved values in or from memory devices, computer processors and other data collection methods, sources and apparatus. The present invention is described herein with methods and systems for correction of data in PCR (polymerase chain reaction), such as quantitative polymerase chain reactions (qPCR), but this description is not to be limiting to the invention as one of skill in the art can apply the described methods and systems to other data, sources, and apparatus.

Methods of analysis of data for qPCR, prior to the present invention, involve the fitting of portions of the data set to mathematical models that were developed either to predict trends in the raw data so as to describe trends in the log-transformed and/or subsequent derivative data. Each of these models makes assumptions about the underlying processes that govern the reaction and none of these models can accurately describe the entire amplification profile. The present invention comprises application of a mathematical model of PCR that accurately describes the entire amplification profile to assess the quality of the data and also the relative quantities of templates, which is a goal of qPCR. The accuracy and reproducibility of quantification in the methods and systems for the present invention is better than other methods currently used and the present invention is less affected by signal errors stemming from the assigned baseline or signal loss. The present invention comprises methods for quantification in PCR where fewer measurements are needed of each sample. Such methods and systems are useful for quality assessment of qPCR and for accurate quantification of template abundance using qPCR.

Prior art methods do not describe the biochemical processes of PCR reactions. The methods currently used in the art rely on data points that are near the limit of detection, which are more susceptible to noise. Such methods are sensitive to baseline assignment errors and signal loss and are modeled on the accumulation of signal that is linked to the number of thermal cycles that have occurred, and not to the amount of product. These methods result in biased data. The present invention overcomes the problems found in the current methods and results in more accurate and less biased results and data.

An aspect of the present invention comprises application of a mathematical model that accurately describes the entire PCR reaction profile using only two reaction variables that depict the maximum capacity of the reaction and feedback inhibition. This model allows quantification that is more accurate than existing methods and takes advantage of the brighter fluorescence signals from later cycles. Because the model describes the entire reaction, the influences of baseline adjustment errors, reaction efficiencies, template abundance, and signal loss per cycle could be formalized. The common cycle-threshold method of data analysis introduces unnecessary variance because of inappropriate baseline adjustments, a dynamic reaction efficiency, and also a reliance on data with a low signal-to-noise ratio. The model may be used in methods for fits to raw data to determine template abundance with high precision, even when the data contains baseline and signal loss defects. This reduces the time and cost associated with qPCR and is applicable in a variety of academic, clinical, and biotechnological settings.

The present invention comprises methods and systems that accurately describe PCR throughout the entire reaction profile. Using the present invention, the influences of baseline adjustment errors, signal variations, and reaction efficiency were evaluated and compared to actual experimental data. Using log-transforms of the data for quantification is invalid, despite the fact it is among the most accurate methods to date, and is currently used in many devices for PCR. A determination of target quantity can be accurately obtained by fitting a simulated model to the complete data set data (i) without the need to extract an efficiency value, (ii) without the need for log transformation, and (iii) without concern for the profile shape or baseline value. The present invention allows for quality checks of adjusted data that are based on an accurate description of the entire reaction, not just regions arbitrarily deemed important. An outcome disclosed herein is that fewer replicates are needed to obtain reliable estimates of template quantity. The cost and time associated with qPCR can be greatly reduced.

The present invention comprises methods comprising determining a maximum capacity of reaction based on first data; determining an apparent affinity of accumulated reaction inhibitors based on the first data; generating a second data based upon one or more of the determined capacity of reaction and the determined apparent affinity of accumulated reaction inhibitors; and determining a seed based upon one or more of the first data and the second data. An aspect of a method comprises applying a weighting factor to the first data prior to determining one or more of the determined capacity of reaction and the determined apparent affinity of accumulated reaction inhibitors. An aspect of a method may comprise generating second data by applying the formula

$$yield = prev ( 1 + ( \frac{( max - prev )}{max} ) - ( \frac{prev}{( Kd + prev )} ) ) ,$$

wherein yield is a data point of the second data, max is maximum capacity of reaction, Kd is apparent affinity of accumulated reaction inhibitors, and prev is an amount of template present after a cycle.

An aspect of a method may comprise generating second data by substantially fitting the formula yield=prev×(1+((max−prev)/max)−(prev/(Kd+prev))) to the first data, wherein yield is a data point of the second data, max is maximum capacity of reaction, Kd is apparent affinity of accumulated reaction inhibitors, and prev is an amount of template present after a cycle. An aspect of the method may comprise fitting the formula to the first data using non-linear regression. In a method of qPCR, the seed may be representative of an amount of template DNA. In a method, the seed is determined based upon a minimal difference between the first data and the second data.

A method of the present invention may comprise determining a maximum capacity of reaction based on first data; determining an apparent affinity of accumulated reaction inhibitors based on the first data; generating a second data based upon one or more of the determined capacity of reaction and the determined apparent affinity of accumulated reaction inhibitors, wherein the second data comprises a plurality of data points, each of the plurality of data points associated with a cycle; determining a seed based upon a comparison of the first data and the second data; and determining a third data using the seed as a baseline cycle. A method may further comprise applying a weighting factor to the first data prior to determining one or more of the determined capacity of reaction and the determined apparent affinity of accumulated reaction inhibitors. An aspect of a method of the present invention may comprise generating second data applying the formula yield=prev×(1+((max−prev)/max)−(prev/(Kd+prev))), wherein yield is a data point of the second data, max is maximum capacity of reaction, Kd is apparent affinity of accumulated reaction inhibitors, and prev is an amount of template present after a cycle. Second data may be generated by substantially fitting the formula yield=prev×(1+((max−prev)/max)−(prev/(Kd+prev))) to the first data, wherein yield is a data point of the second data, max is maximum capacity of reaction, Kd is apparent affinity of accumulated reaction inhibitors, and prev is an amount of template present after a cycle. A method of the present invention may comprise substantially fitting the formula to the first data using non-linear regression. In PCR methods, a method may comprise a seed that is representative of an amount of template DNA. A method of the present invention may comprise a seed that is determined based upon a minimal difference between the first data and the second data. An aspect of a method of the present invention may comprise third data that is generated by applying the formula yield=prev×(1+((max−prev)/max)−(prev/(Kd+prev))) to the seed, wherein yield is a data point of the third data, max is maximum capacity of reaction, Kd is apparent affinity of accumulated reaction inhibitors, and prev is an amount of template present after a cycle.

A system of the present invention may comprise a memory storing a first data; a processor in communication with the memory, the processor configured to determine a maximum capacity of reaction based on the first data; to determine an apparent affinity of accumulated reaction inhibitors based on the first data; to generate a second data based upon one or more of the determined capacity of reaction and the determined apparent affinity of accumulated reaction inhibitors; to determine a seed based upon one or more of the first data and the second data. A system of the present invention may further comprise applying a weighting factor to the first data prior to determining one or more of the determined capacity of reaction and the determined apparent affinity of accumulated reaction inhibitors. A system of the present invention may generate second data using an appropriate apparatus that applies the formula yield=prev×(1+((max−prev)/max)−(prev/(Kd+prev))), wherein yield is a data point of the second data, max is maximum capacity of reaction, Kd is apparent affinity of accumulated reaction inhibitors, and prev is an amount of template present after a cycle. A system of the present invention may generate second data using an appropriate apparatus that substantially fits the formula yield=prev×(1+((max−prev)/max)−(prev/(Kd+prev))) to the first data, wherein yield is a data point of the second data, max is maximum capacity of reaction, Kd is apparent affinity of accumulated reaction inhibitors, and prev is an amount of template present after a cycle. A system of the present invention may determine a seed based upon a minimal difference between the first data and the second data.

Noise in experimental data can be reduced by increasing the number of measurements because noise does not scale linearly with true signal. For example, to reduce random noise by half, the number of measurements needs to be squared (Goldman 1968). Unfortunately, for investigators using qPCR to quantify DNA, this relationship means that if a two-fold reduction in error bars is required in a particular project, the number of measurements will need to increase from a typical number of 3 to 9 for each sample, thus squaring the cost and dedicated time as well. A method of the present invention may reduce the measurement noise so that differences between samples can be determined with fewer measurements.

Existing qPCR analysis methods can produce high data variance, which complicates the measurement of many targets from a large collection of cDNA libraries. A major contributor of the variance may be a contribution of improper automated baseline assignment and a very slight loss of fluorescence efficiency each time a measurement was made. In the raw data, the effect is nearly imperceptible, but in the log transforms used for the fitting during Cₜ analysis, the effect is dramatic and heavily distorts the early data points in the amplification profile. An appropriate correction is disclosed herein and the data may then be adjusted prior to Cₜ analysis, which reduces such variance.

A software program (Ruijter et al., 2009) that automates the baseline adjustment to maximize the linearity of the log transformed data was tested using the methods and systems of the present invention (Ruijter et al., 2009). During those tests, the calculated efficiency terms were sometimes greater than 100%, which is impossible by the current understanding of PCR. Because adding or subtracting values created a desired linear trend in log-transformed data, whether it was appropriate to arbitrarily adding or subtracting values to experimental data was determined. Without a model to accurately evaluate the influence of baseline adjustments, a reliance on a decrease in variance between repeated samples as the only measure to show correct assumptions.

The various kinetic events that underlie the amplification step have been rigorously evaluated mathematically (Peccoud et al., 1996; Stolovitzky et al., 1996); however, such modeling fails to capture the increases in signals that arise from completed amplifications that are at equilibrium. Also, there are so many dynamic parameters in a complete kinetic analysis of PCR that fitting real data is intractable. A mass action exponential model that predicts the data early in an amplification profile and yields an accuracy comparable to the Cₜ method was employed by others (Ruijter et al., 2009; Boggy et al., 2010). However, this method is similarly influenced by well-to-well variations in the profile shapes that stem from a collection of uncontrollable variables including optical precision, reaction volume, and a dynamic efficiency term.

Because PCR reaction profiles resemble sigmoids, several groups have developed various sigmoidal models in an attempt to extract efficiency and threshold values that can then be used for calculating relative abundance, despite the fact that there is no obvious sigmoidal process underlying the increase in signal (Liu et al., 2002; Spiess et al., 2008; Rutledge et al., 2008). As with any mathematical modeling, adding more variables to improve data fits is not necessarily warranted, and sigmoidal fitting methods are not as reproducible as log-transform threshold analysis when baselines are properly adjusted (Ruijter et al., 2009). A fifth parameter in sigmoid analysis was implemented to account for asymmetry around the sigmoidal inflection point (Spiess et al., 2008). Different inflection points in data for the same template in different wells of the same experiment occur, so the physical relationship between an infection point and the amount of template is not clear. It is theorized that difficulties in fitting qPCR profiles with sigmoids arise because the transitions into and out of the dynamic region of the data are differentially influenced by the max and K_{d} terms. The asymmetry around the inflection point indicated to us that there are at least two processes governing the cessation of a PCR reaction.

The implementation of reagent depletion as a modulator of efficiency made sense for a closed system. At first glance, one might expect that the max term should remain essentially constant between different samples when using the same master mix. However, this value is also influenced by the signal strength in each well, so differences in machine calibration, optical alignment, and reaction volumes can each influence the apparent yield in different measurements of the same target. It was the addition of the feedback-inhibition term that permitted highly accurate fitting. The entire mass action event could be described with a single “inhibitor” and a single apparent K_{d} value, especially considering that two dominant products, dsDNA and pyrophosphate, accumulate at different scales. For each mole of dsDNA produced in a typical qPCR experiment, there are approximately 200 moles of pyrophosphate liberated. Despite this, adding additional terms to the efficiency component of the equation did not improve the fitting accuracy to any degree that influenced the final quantification because experimental data is described very well with Equation (6).

The lack of dependence on the length of the baseline indicates that as long as a few baseline cycles are available for accurate global fitting, the timing of the appearance of the amplification profile (stemming from the abundance of the initial template) does not affect the calculations. Initial target abundance should only be a consideration in cases where there is a trace amount of target and competing side-reactions markedly influence the data. Therefore, comparisons of the melt-curves and product uniformity can still ensure that the correct dsDNA is being monitored and standard data quality guidelines should still be employed (Bustin et al., 2009).

Remaining hurdles in accurate quantification now stem from true statistical variations in the amount of template added, from poorly-calibrated machines, and also from liquid handling. Commercial qPCR mixtures of enzyme, reporter, dNTPS, buffer, salts, and stabilizer substantially reduce sample-to-sample variation and allow reproducibility over long time scales. Accurately distributing the mixes containing primers to each sample well is challenging and variable because the mixtures are viscous and have high affinity for the plastic pipette tips and wells. This property also makes thorough pre-mixing of the input template difficult and so most mixing likely occurs during the first few cycles from thermal convection, which may also influence the measurement of apparent starting amount. Being appropriately trained in handling such liquids is crucial, and the importance of ensuring that consistent (rather than accurate) volumes are delivered to each well cannot be overemphasized. However, multiple measurements of the same sample can now have a greater impact on reducing scatter in abundance calculations because each individual determination can be made more accurately.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

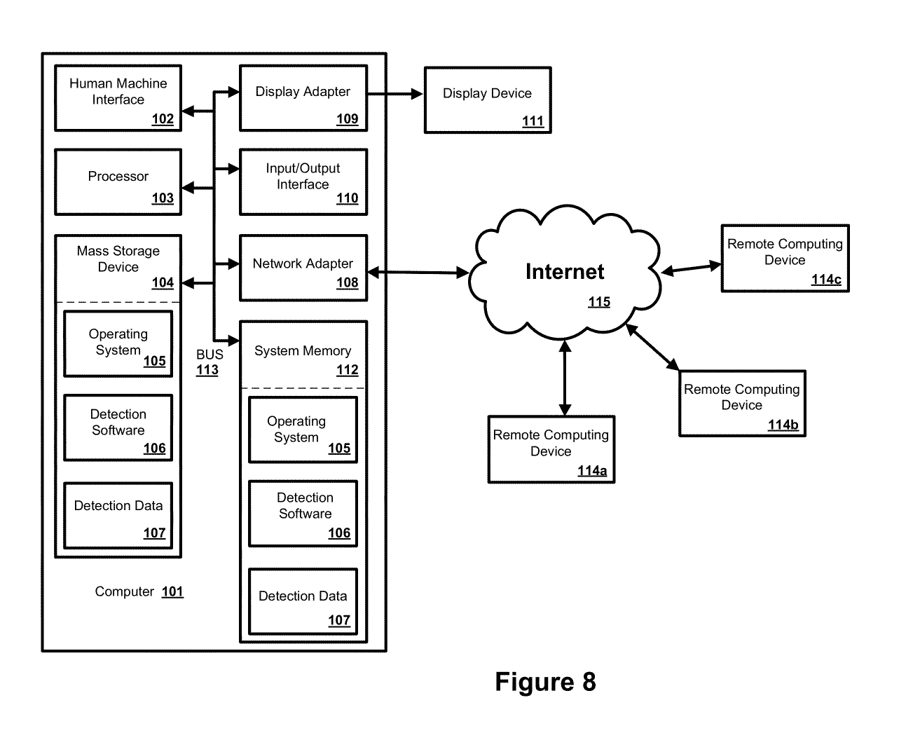

FIG. 8 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (USA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, detection software 106 (e.g., seed generation/processing software), detection data 107 (e.g., seed related data, capacity of reaction data, apparent affinity of accumulated reaction inhibitors, and the like), a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as detection data 107 and/or program modules such as operating system 105 and detection software 106 that are immediately accessible to and/or are presently operated on by the processing unit 103.

In another aspect, the computer 101 can also comprise other removable/non-removable, volatile/non-volatile computer storage media. By way of example, FIG. 8 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and detection software 106. Each of the operating system 105 and detection software 106 (or some combination thereof) can comprise elements of the programming and the detection software 106. Detection data 107 can also be stored on the mass storage device 104. Detection data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device. Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers and a printer, which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of detection software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

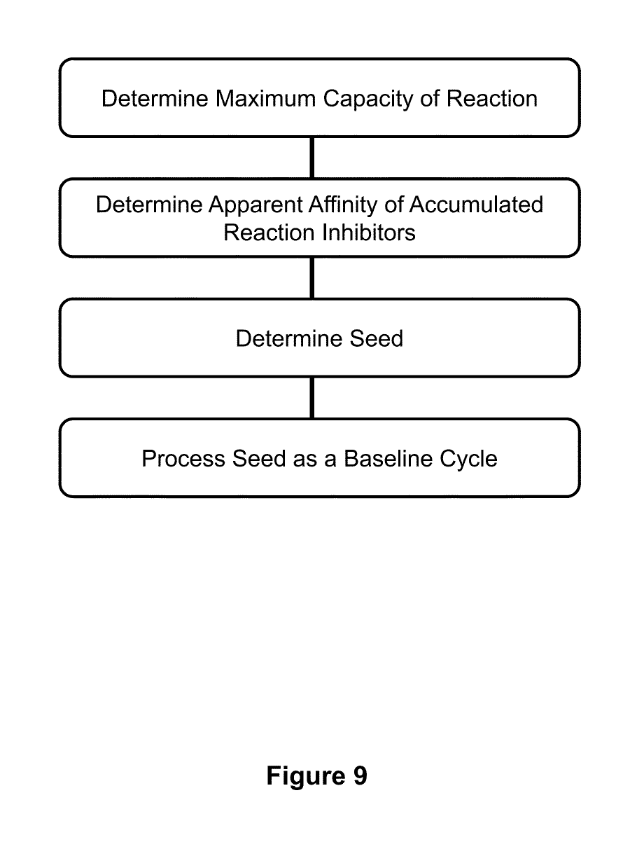

In an aspect, one or more computing devices, such as computer 101, can be used to execute at least a portion of the methods described herein. For example, FIG. 9 illustrates an exemplary method according the present disclosure.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

It is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

### REFERENCES

Axelrod D, et al. (1976) Mobility measurement by analysis of fluorescence photobleaching recovery kinetics. Biophys J 16: 1055-1069.
Boggy G J, et al. (2010) A mechanistic model of PCR for accurate quantification of quantitative PCR data. PLoS ONE 5: e12355.
Bustin S A, et al. (2009) The MIQE guidelines: minimum information for publication of quantitative real-time PCR experiments. Clin Chem 55: 611-622.
Eischeid A C. (2011) SYTO dyes and EvaGreen outperform SYBR Green in real-time PCR. BMC Res Notes 4: 263.
Goldman S. (1968) Information theory. New York, Dover Publications.
Higuchi R, et al. (1993) Kinetic PCR analysis: real-time monitoring of DNA amplification reactions. Biotechnology (NY) 11: 1026-1030.
Holland P M, et al. (1991) Detection of specific polymerase chain reaction product by utilizing the 5′→3′ exonuclease activity of Thermus aquaticus DNA polymerase. Proc Natl Acad Sci USA 88: 7276-7280.
Kim Y J, et al. (2008) Characterization of a dITPase from the hyperthermophilic archaeon Thermococcus onnurineus NA1 and its application in PCR amplification. Appl Microbiol Biotechnol 79: 571-578.
Liu W, et al. (2002) Validation of a quantitative method for real time PCR kinetics. Biochem Biophys Res Commun 294: 347-353.
Moelwyn-Hughes E A, et al. (1930) The Kinetics of Enzyme Reactions: Schutz's Law. J Gen Physiol 13: 323-334.
Mullis K, et al. (1986) Specific enzymatic amplification of DNA in vitro: the polymerase chain reaction. Cold Spring Harb Symp Quant Biol 51 Pt 1: 263-273.
Mullis K B, et al. (1987) Specific synthesis of DNA in vitro via a polymerase-catalyzed chain reaction. Methods Enzymol 155: 335-350.
Page R B, et al. (2011) Linear methods for analysis and quality control of relative expression ratios from quantitative real-time polymerase chain reaction experiments. Scientific World Journal 11: 1383-1393.
Park S Y, et al. (2010) Facilitation of polymerase chain reaction with thermostable inorganic pyrophosphatase from hyperthermophilic archaeon Pyrococcus horikoshii. Appl Microbiol Biotechnol 85: 807-812.
Peccoud J, et al. (1996) Theoretical uncertainty of measurements using quantitative polymerase chain reaction. Biophys J 71: 101-108.
Ramakers C, et al. (2003) Assumption-free analysis of quantitative real-time polymerase chain reaction (PCR) data. Neurosci Lett 339: 62-66.
Ruijter J M, et al. (2009) Amplification efficiency: linking baseline and bias in the analysis of quantitative PCR data. Nucleic Acids Res 37: e45.
Rutledge R G. (2004) Sigmoidal curve-fitting redefines quantitative real-time PCR with the prospective of developing automated high-throughput applications. Nucleic Acids Res 32: e178.
Rutledge R G, et al. (2008) A kinetic-based sigmoidal model for the polymerase chain reaction and its application to high-capacity absolute quantitative real-time PCR. BMC Biotechnol 8: 47.
Rutledge R G, et al. (2008) Critical evaluation of methods used to determine amplification efficiency refutes the exponential character of real-time PCR. BMC Mol Biol 9: 96.
Rutledge R G, et al. (2010) Assessing the performance capabilities of LRE-based assays for absolute quantitative real-time PCR. PLoS ONE 5: e9731.
Saiki R K, et al. (1985) Enzymatic amplification of beta-globin genomic sequences and restriction site analysis for diagnosis of sickle cell anemia. Science 230: 1350-1354.
Spiess A N, et al. (2008) Highly accurate sigmoidal fitting of real-time PCR data by introducing a parameter for asymmetry. BMC Bioinformatics 9: 221.
Stolovitzky G, et al. (1996) Efficiency of DNA replication in the polymerase chain reaction. Proc Natl Acad Sci USA 93: 12947-12952.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

### Quantitative PCR

### Materials and Methods

### Quantitative PCR

Complementary DNA libraries were generated from E. coli total RNA using a commercial kit (Bio-Rad iScript cDNA synthesis kit). Commercial qPCR master mixtures were from various sources (Bio-Rad: IQ SYBR® Green Supermix or SsoFast EvaGreen® Supermix; Applied Biosystems SYBR Green® PCR master mix). Quantitative PCR was performed on several machines (Applied Biosystems 7500 Fast®, Bio-Rad iCycler®, Bio-Rad IQ®, and Bio-Rad MiniOpticon®). All reactions were run with 40 cycles and the target PCR products ranged from 90 to 120 base pairs.

### Data Analysis

Cycle-threshold analysis was performed using either on-board software or exported and analyzed with or without additional baseline adjustments using the LinRegPCR software (Ruijter et al., 2009). Sloping baseline adjustments and signal-loss-corrections were made using Microsoft Excel. Global fitting to obtain max and K_{d} was performed using Kaleidagraph (Synergy Software). The fitting was recursive (each ordinate value depended on the previous ordinate, not on the abscissa), so two adjacent columns of data were used, one containing the raw values from cycles 3 through 39, and the adjacent containing the data to be fitted with cycles 4 through 40. A final column contained the weights for each data point based on the relative intensities of the fluorescence. Kaleidagraph interprets a value of one as having the most weight and larger values having less weight. Therefore, weights were scaled linearly to match the relative brightness of each measurement compared to the maximum brightness observed in the reaction, which was usually the last data point. Weights were calculated using Equation (1) shown below:

$$weight = ( \frac{1}{abs ( \frac{data}{brightest} )} ) ,$$

where the weight applied to a given data point was the absolute value (abs) of the current data point divided by the largest data point (brightest). Because max and K_{d} values were sought that described the shape of the amplification profile as accurately as possible, weighting was implemented to lessen the impact of long or drifting baselines and weak signals. Fitting was accomplished by plotting the raw data versus the cycle number and activating non-linear regression using the PCR formula with weighting included. For each cycle, Kaleidagraph fitting required a table function to use a data column containing the template abundance from the previous cycle to calculate of the amount of product yield expected. Therefore, the following formula (i.e., Equation (2)) was used:

$$y = table ( m 0 , c 0 , c 1 ) \times ( 1 + ( \frac{( m 1 - table ( m 0 , c 0 , c 1 ) )}{m 1} ) - \frac{table ( m 0 , c 0 , c 1 )}{( m 2 + table ( m 0 , c 0 , c 1 ) )} ) ;$$

$$m 1 = 10 ; m 2 = 1 ; ,$$

where m0 is the cycle number, m1 is max, and m2 is K_{d}. The data was present in columns c0, c1, c2, and c3 contained the cycle number, the previous signal, the current signal, and the weights respectively. The plot was generated using columns c0 and c2. The initial guesses for the non-linear fitting (10 and 1 in this case) were approximated to be on the same scale as the raw data.

The max and K_{d} values from this weighted fit were then exported to an Excel spreadsheet. A “seed” cell contained an initial guess of the amount of signal that was present in the cycle immediately preceding the model window. A column of simulated data was then generated by having the first cell reference the seed cell and applying PCR Equation (6) using the values of max and K_{d} from the weighted fitting for that particular reaction. Each subsequent cell in the column used the same max and K_{d}, but referred the amount present in the cell above it as prev. An example of the formula used for this progression is Equation (3) as shown below:

$$= G 2 \times ( 1 + ( \frac{( \$ B \$16 - G 2 )}{\$ B \$16} ) - ( \frac{G 2}{( \$ B \$17 - G 2 )} ) ) ,$$

where $B$16 was the cell containing max, $B$17 was the cell containing K_{d}, and G2 was the cell above the current. When needed, subsequent columns of simulated data were generated that incorporated baseline drift or signal loss by referring to these “perfect” values. Real data was placed in a column and the difference between the simulated and real data was calculated and squared as an additional column. Finally, an output cell was created that contained the sum of the squared difference values. Using the included Solver GRG non-linear method in Excel, the value of the seed cell was drifted in order to minimize the sum-of-squares in the output column. When very small seed values were needed (for example when early cycles were being used for the quantification), both the convergence and constraint precision were adjusted to include more zeroes after the decimal. However, choosing a cycle near the beginning of the above-baseline signal did not require any adjustment for a solution to be found.

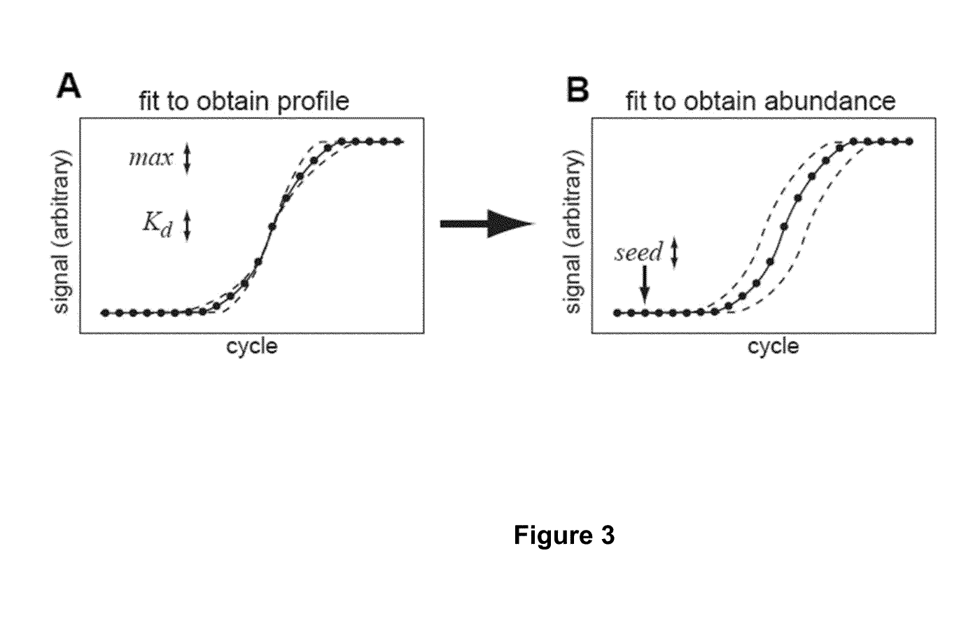

The Excel Solver reports the seed value, in arbitrary fluorescence units, that gave rise to the simulated data in the model being superimposed on the experimental data. These seed values were then used to calculate relative abundances between samples (schematized in FIG. 3). Floating all three terms (seed, max, and K_{d}) simultaneously was evaluated along with other terms that influence reaction efficiency and data quality. The conclusion was that using a weighted fit to obtain max and K_{d} yielded terms that more accurately described the shape, and using non-weighted fitting for determining seed amounts yielded more reproducible data. Thus, a two-stage fitting procedure was used.

Development of a PCR Equation that Models all Data

Most attempts to model PCR reactions begin with the consideration that the reaction is exponential in nature with a nearly-constant amplification efficiency in the cycles preceding the data that is used for quantitative analysis (typically near the region the signal begins to leave the baseline) (Page et al., 2011). Such approaches are based on the mathematical prediction that the reaction proceeds, in some form, following the equation (i.e., Equation (4)):

yield=initial×efficiency^{#cycles}.

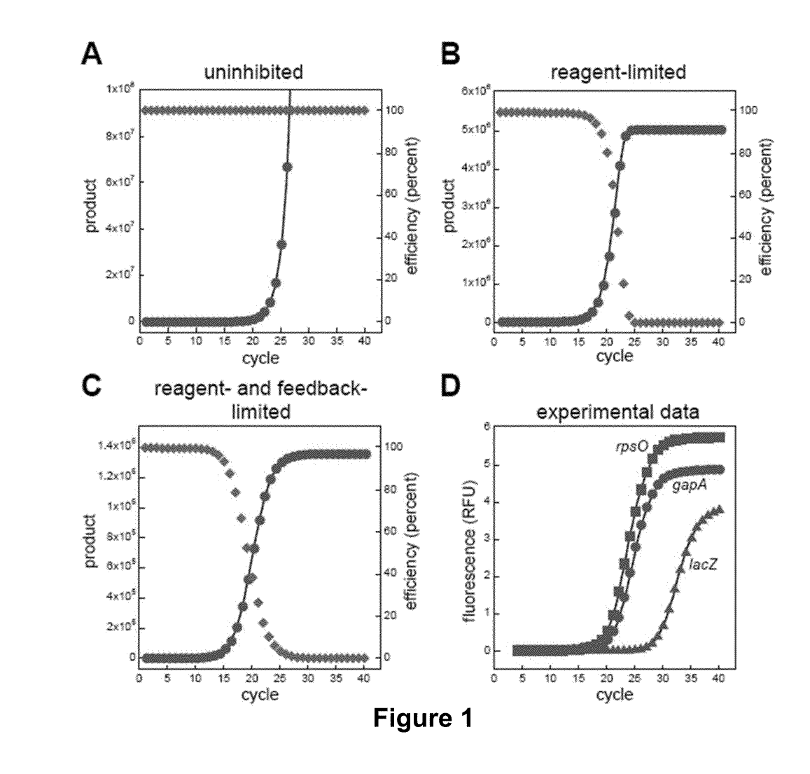

In this equation, the amount of starting material (initial) and the amplification efficiency govern the product yield after a certain number of thermal cycles (Ruijter et al., 2009). In a perfect setting, the efficiency equals two, meaning that each template gives rise to two product dsDNAs per cycle. In practice, measured efficiencies are less than two and range typically from ˜1.8-1.95 (Ruijter et al., 2009; Rutledge et al., 2010; Page et al., 2011). The fundamental problem with this simplified view of a PCR reaction is that the reaction is predicted to generate a purely exponential expansion and such a behavior is not observed in a real setting (FIG. 1). In a closed system, substrate reagents become limiting as the reaction proceeds. Therefore, the basic PCR equation was modified such that the efficiency-per-cycle was influenced by the amount of available reagents. Because the amount of remaining reagent is directly proportional to the amount of product that was formed in preceding cycles, the fractional remaining reagent at the beginning of any given cycle can be described by the operation:

$$\frac{( max - prev )}{max} ,$$

where max is the maximum amount of product that could possibly form and prev is the amount of DNA product present after the previous thermal cycle. The PCR model was changed to predict only the yield of product formed in one cycle. The modified PCR equation then became Equation (5):

$$yield = previous \times ( 1 + ( \frac{max - prev}{max} ) ) .$$

Here, the efficiency term in parentheses is dynamic and scales from a value near 2 (when very little product has been formed) to a value near 1 (no amplification, when all of a limiting reagent has been converted to product). When modeled, the resulting data from Equation (5) yields the profile observed in FIG. 1(B). Notably, the reaction is nearly 100% efficient until product accumulates to the point that the reagent pool has been markedly influenced. The reaction displays a sharp transition from nearly-exponential product formation to a flat plateau because most of the reagent is consumed in the few cycles preceding max. Although this equation generates data that is reminiscent of qPCR data, it was unable to fit any of the experimental data.

The investigation into the cause of this failure caused reconsideration of the prevailing notion that PCR reactions stop because of reagent limitation. A common perception is that the oligonucleotide primers become limiting, most likely because their initial quantity was demonstrated to influence product yield in early reports of PCR (Mullis et al., 1986; Higuchi et al., 1993). When the amount of dsDNA produced from PCR reactions that had plateaued was measured and compared them to the available primer concentration, the product yields observed were only approximately 20-25% of the available primer and far below the amount of available deoxynucleoside triphosphates. Therefore, some other process must be responsible for stopping PCR reactions.

The law of mass action dictates that, in a closed system, an enzymatic reaction rate is necessarily reduced as product accumulates (Moelywn-Hugest et al., 1930). This phenomenon is the reason why most kinetic analyses are performed from initial rates, before substantial product accumulates. Therefore, because PCR occurs in a closed system, it was concluded that the efficiency of a PCR reaction must be also influenced by the amount of product that had been produced in previous cycles. In its simplest form, the product can be modeled as an inhibitor with an unknown affinity for the enzyme. The fractional occupancy of an inhibitor for an enzyme is described by Mailman 2008:

$$occupancy = \frac{{[ inhibitor ]}_{free}}{( {K}_{d} + {[ inhibitor ]}_{free} )} ,$$

where the unbound (free) concentration of inhibitor dictates the occupancy of the enzyme with respect to its equilibrium dissociation constant (K_{d}). During PCR, the amount of such an inhibitor is also directly proportional to the amount of product formed in previous cycles. The model was modified such that the per-cycle efficiency was influenced both by a limiting reagent as described in Equation (5) and also by the accumulation of inhibitory product to arrive at the final PCR equation (i.e., Equation (6)):

$$yield = prev ( 1 + ( \frac{( max - prev )}{max} ) - ( \frac{prev}{( Kd + prev )} ) ) .$$

Now, two components govern the amplification efficiency at each cycle and each is solely dependent on the amount of product that was present at the end of the previous cycle. One effector changes from a value of one to zero and the other changes from a value of zero to one. Thus, the overall efficiency drifts from early values near 100% to near 0% as the product accumulates. Simulated data generated from Equation (6) is shown in FIG. 1(C). Consistent with observed qPCR data and depending on K_{d}, it displays a rounded transition from near-exponential amplification to a plateau that sits at ˜25% of the maximum possible yield. After the first thermal cycle, the efficiency is never perfect, nor is it constant, which is consistent with previous calculations (Liu et al., 2002; Rutledge et al., 2008).

This PCR equation was tested for its ability to describe a variety of real experimental data using non-linear regression and floating only two variables, max and K_{d}. The equation was able to very accurately describe every analyzed amplification profile with R factors typically greater than 0.999 (FIG. 1(D)). Accurate fitting was observed on data generated by older qPCR machines with dim lighting sources, on data that is scaled to ˜5 (Bio-Rad) and data that is scaled to ˜5 million (ABI), and on data generated with different fluorescence reporters. Because proprietary commercial qPCR master mixes was used, there was no ability to predict max; yet, the fitting returned max values that were approximately 4-fold higher than the observed plateaus, which was consistent with the simulated, perfect model in which the reaction ceased primarily from the accumulation of an inhibitory product. Additionally, the values obtained for K_{d} were approximately 1/10th of max. This outcome was also predicted from the modeling of a perfect reaction. Because the signal analyzed in qPCR is an arbitrarily-scaled fluorescence signal, the observed values of K_{d} have no direct physical link to the presence of any particular inhibitory product. Rather, they serve simply to control the slowing of the reactions as product accumulates. Each experimental reaction displayed a unique max and K_{d} that governed the shapes of the curves.

Equation (6) was rearranged such that it was solved for prev and equated to all other values. However, solving for prev yields three solutions, two imaginary and one real. The real solution is exceedingly complex with 44 instances of exponentials. Therefore, very small errors in the data measurement become egregiously amplified during the solution.

Baseline Adjustment Errors and their Impact on Data Analysis

Viewing the qPCR data with the software on various machine models highlighted an obvious defect in some data sets. When the data was viewed in log form, early cycle data trended downward, then data disappeared, and the remaining data curved up from the gap into the region to be used for cycle-threshold analysis. Consecutively absent data from the log transform was caused by consecutively negative data. Because dsDNA was being produced in these early cycles, this trend was an impossibility. The influence of improper baseline adjustment was noticed and a useful tool was created to automate the baseline assignment such that the earliest data above background was as linear as possible (Ruijter et al., 2009). One feature of this approach is that the most linear pre-corrected data is used as a guide to adjust the data preceding it (i.e., to match the same linear trend as closely as possible). These adjustments reduced the variances in the analyses reported herein. In effect, that method imposed an efficiency on preceding data. When some output efficiency values were over 100%, it was realized that relying on variance as the only guide to evaluate data correction could lead to bias.

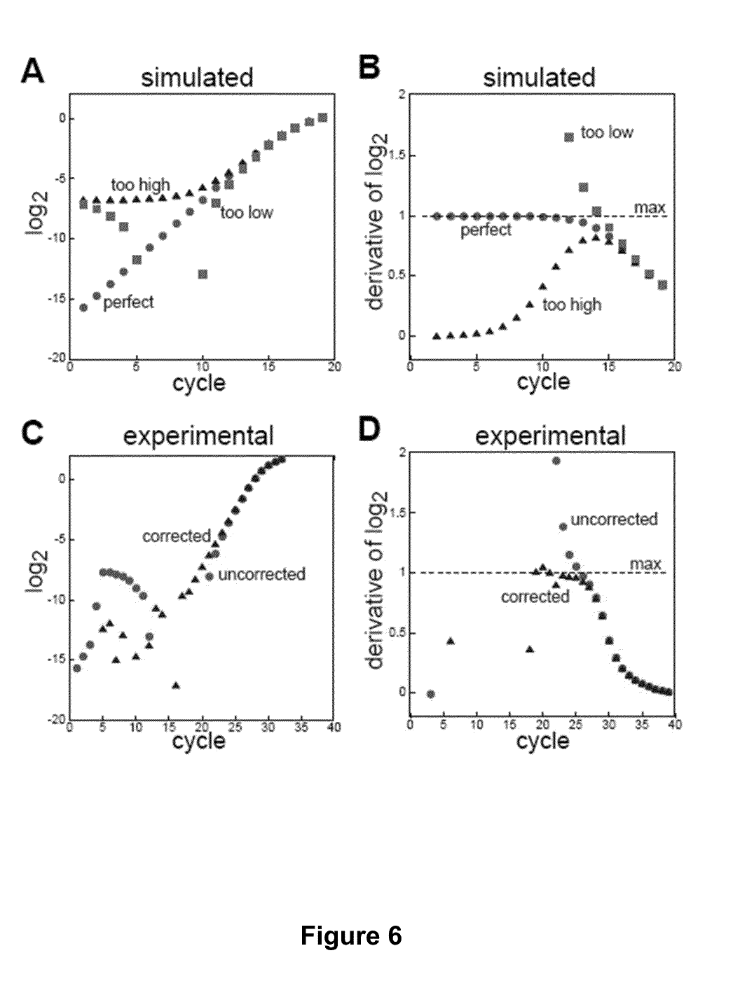

The PCR Equation (6) is a model to test the influence of incorrectly applied baseline adjustments, which appeared to be the root cause of the data defects. Once a model was developed that accurately described real data, baseline values were added and subtracted to all data in the simulated, perfect set to observe the changes in the log transforms and their derivatives, which reported the apparent efficiencies (FIG. 6). When a small baseline value of 0.1% was added to the simulated data, the log transforms of the data deviated from the perfect set and leveled off at early cycles (FIG. 6(A)—“too high”). When the derivative of these data was plotted, the maximum apparent efficiency was well below the true efficiency in those same cycles (FIG. 6(B)).

To recapitulate the experimental observation that the log data disappeared and reappeared, a non-uniform baseline adjustment was applied to the data. When a fixed amount was added to all of the data and then subtracted a value from each data point that increased as a function of the number of cycles, the curving disappearance/reappearance in the log-transformed data was mimicked (FIG. 6(A)). The downward curved trend in the log data that approached the linear region was visually indistinguishable from data that had been modified by removing a uniform amount from each point. Also, the apparent efficiencies in early cycles was above the theoretical limit (FIG. 6(B)). Thus, downward or upward curve trends in the log transforms of regions where Cq is calculated are indicative of improper baseline assignments. The derivative curve shape is a reliable indicator of the quality of the data that can be used prior to employing a quantification method. The derivative data should trend to a level value that sits just under the theoretical maximum.

With real data, low signal-to-noise in the earliest cycles causes the log and derivative plots to have scattered data. For the experimental data shown in FIG. 6(C) and FIG. 6(D), raw data was compared before and after a baseline adjustment that involved correcting both for a uniform loss (imposed by the machine automatically over-subtracting in an attempt to establish a zero baseline) and from a decline the in the signal strength that was a function of the number of cycles. The log-transform of the corrected data appears straight as it becomes detectable above background. The derivative plot trends toward the theoretical limit in efficiency, unlike the uncorrected data (FIG. 6(D)). Note that the data points with stronger signals (later in the reaction) are relatively unaffected by errors in baseline adjustment because the defect is small relative to the overall signal. The global fitting procedure described in the main body of the manuscript takes advantage of this feature and is practically unaffected by baseline errors. In fact, adding an artificial baseline to real data that was 20% of the maximum signal did not prevent a reliable analysis.

Signal Loss During Cycling

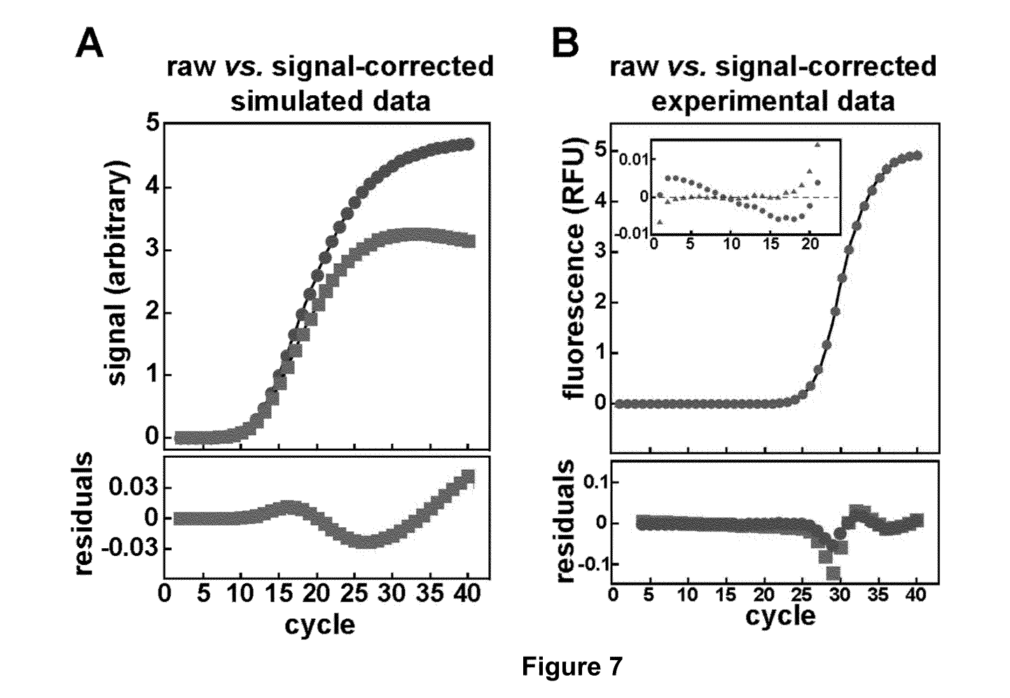

In some cases, experimental data was observed that exhibited striking declines in the signals of the plateau regions as the cycling continued after the completion of the amplification stage. This observation is relevant as the product DNA is not depleting during those cycles. But rather, the fluorescence reporter is most likely photobleaching. The bleaching occurs throughout the entire reaction each time a measurement is made and influences all of the data, not just the plateau region. It only becomes overt when the accumulation of product has slowed sufficiently (FIG. 7(A)). In most cases, data that has been distorted by repetitive signal loss is indistinguishable from a normal qPCR profile (FIG. 7(B)).

The loss in signal from photobleaching is a first-order process and, because measurements are made with repeated, nearly-consistent exposures to light, the amount of active fluorophore remaining after each measurement is a fixed fraction of what was present before the measurement (Axelrod et al., 1976). The cycle-dependent loss can be described by Equation (7):

observed=real×(signal remaining)^{cycle#}.

In this scenario, the number of exposure cycles that have occurred prior to each measurement can substantially alter the data and influence reproducibility, especially when rarer templates require a greater number of cycles to be detectable. The steps to rearrange Equation (7) to solve for real are:

1. divide by real:

$${( remaining )}^{\# cycles} = \frac{observed}{real}$$

2. take the log:

cycle#×log(remaining)=log(observed)−log(real)

3. subtract log(observed):

cycle#×log(remaining)−log(observed)=−log(real)

4. multiply by −1:

log(observed)−cycle#×log(remaining)=log(real)

5. choose a log base:

log₂(observed)−cycle#×log₂(remaining)=log₂(real)

6. raising the equation to the selected log base (2 in this case) yields an equation that allows correction for the consistent signal loss (i.e., Equation (8)):

real=2^{(log}^{₂}^{(observed)-(cycle#×log}^{₂}^{(remaining)))}.

Applying Equation (8) to simulated PCR data that has undergone signal loss restores the normal appearance of the amplification profile (FIG. 7(A)). The experimental challenge is to accurately determine the signal loss as a function of what was present before the measurement. Such a determination is difficult, and is made impossible if data has already been baseline adjusted. However, PCR Equation (6) still fits such damaged data and extract values for max and K_{d} that allow for template quantification (FIG. 7(A)). In a real setting, there is no clear indication that the data being analyzed has been distorted by such a dynamic process because the log and derivate plots barely change (FIG. 7(B)). Trended residuals of the fit to PCR Equation (6) provides an indication that the data is non-ideal and this feature can be used to assess data quality.

Fluorescent reporters that are more stable are less prone to induce this artifact and that the commonly used SYBR® Green can noticeably bleach (Eischeid 2011). Also, older machines with dimmer excitation lights spare the fluorophore at the expense of generating noisier data. These observations are the reason a weighting procedure to the data points with the highest signals was implemented during the fitting to obtain max and K_{d}. As a precaution, the “loss per cycle” term from Equation (7) can be added in the spreadsheet equation that generates the simulated data for the calculations of abundance and simultaneously floated along with the seed amount during the minimization of the sum of squares. Because the distorted data is still well-fit by Equation (6), the solution should return a value very near 100% as the amount of active fluorophore remaining per cycle, even if that is known not to be the case.

These data defects have a high impact on Cₜ analysis accuracy, especially when the C_{q} between compared samples are separated by several cycles. An automated process can be implemented that applies the signal-loss-correction in conjunction with baseline assignments in an effort to minimize the residuals to the fit to Equation (6). Another consideration is a loss in enzymatic activity per cycle, which was not explicitly included in the model. A loss in enzymatic activity is expected to be reflected as changes to the apparent K_{d} of an inhibitor as a function of the number of cycles.

A PCR equation that describes the product accumulation throughout an entire qPCR data set using three variable terms: the amount of template present after the previous cycle (prev), the maximum capacity of the reaction (max), and the apparent affinity of accumulated reaction inhibitors (K_{d}) was discovered. As with the mass action kinetic model that describes exponential PCR phases with two parameters (Boggy et al., 2010), the model is recursive in that product accumulation is dependent on the amount of template present after the previous cycle (prev). Equation (6) is as follows:

$$yield = prev ( 1 + ( \frac{( max - prev )}{max} ) - ( \frac{prev}{( Kd + prev )} ) ) .$$

The amplification efficiency (in parentheses) in each cycle varies. It changes from a value of two (100% efficient) to a value of one (0% efficient) as the PCR develops. Unlike other PCR models, this equation enables accurate modeling of entire data sets and is unaffected by cycle number, curve shape, or plateau height. Applying Equation (6) to fit experimental data using nonlinear regression allows for determination of unique max and K_{d} values for a wide variety of reactions (FIG. 1).

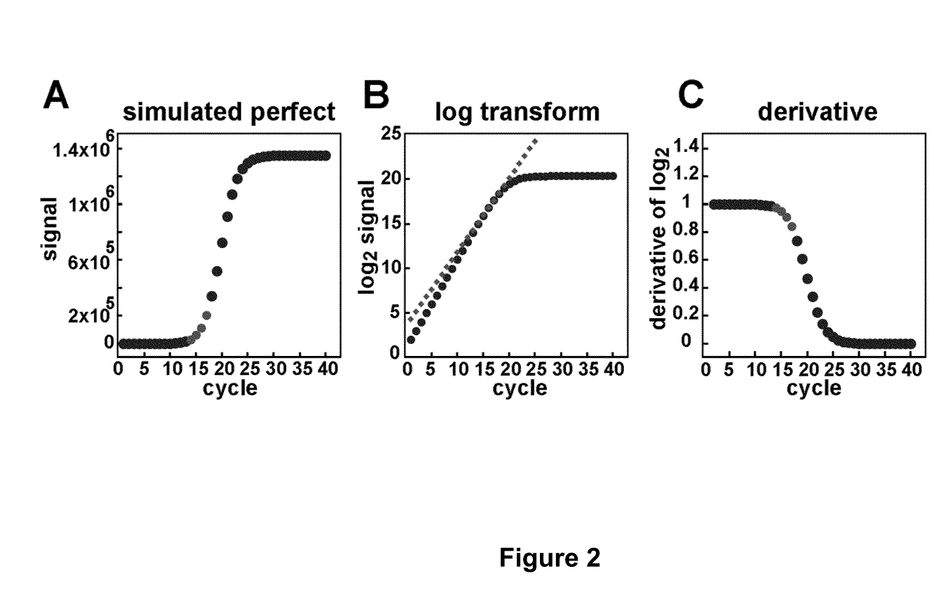

With an equation that accurately describes PCR, evaluation of a very common method of qPCR analysis that relies on log-transformation of the data was performed. In comparative “cycle threshold” analysis (Cₜ), regions of log transforms of the data are fit to straight lines and the slopes and intercepts from these fits are then used to calculate reaction efficiencies and quantification cycles (C_{q}). With the assumption that the reactions are purely exponential and that there is a constant efficiency, back-calculations are made from the differences in C_{q} that report the relative differences in starting abundance. Perfect PCR data was simulated using Equation (6) and evaluated it using cycle threshold analysis. The simulated data was transformed into log form and the slopes and derivatives analyzed (FIG. 2). Two points became clear. First, because the efficiency changed for each cycle, the log transforms are not truly linear, even though they visually appear so during early cycles. Second, once the product has accumulated to the point that the data leaves the apparent baseline, the reaction can be undergoing dramatic losses to its efficiency. Thus, calculating apparent reaction efficiency from data in this region always leads to an underestimation of the average efficiency in cycles preceding that window, a point that was previously predicted using sigmoidal analysis methods (Rutledge et al., 2008). Moreover, using a straight line to fit threshold data points to estimate the starting amount is extremely sensitive to mis-adjusted baselines (Rutledge et al., 2010). In summary, cycle threshold analysis suffers mainly from the fact that the efficiency always changes and that all of the calculations are based on a few data points near the baseline that have the weakest signal-to-noise ratio.

Quantification of Template Abundance Using Regression

To determine the relative amounts of template DNA in a sample set, an empirical calculation of template abundance in early cycles was employed that allowed data modeled with the extracted max and K_{d} terms to become superimposable with experimental data (provided above). To accurately determine max and K_{d} for each reaction, experimental data was first fitted to Equation (6) with fitting weight given to the brighter signals. These values were then used in a spreadsheet to model synthetic data using the same PCR equation. The differences between the modeled and experimental data for each observation were then calculated, squared, and summed. For the modeled data, the template amounts in an early cycle spreadsheet cell governed all subsequent values. Thus, by computationally searching for a template “seed” amount present after a cycle that minimized the differences between the modeled and experimental data, an accurate determination of the amount that was present in the real data at any point along the profile was determined, even in the baseline region where the real signal was unobservable above background (FIG. 3). In effect, by altering the amount of template present after an arbitrary early cycle, the position of the modeled curve was adjusted to fit on top of the experimental data. Once aligned, the template abundances in each cycle were available from the modeled spreadsheet data.

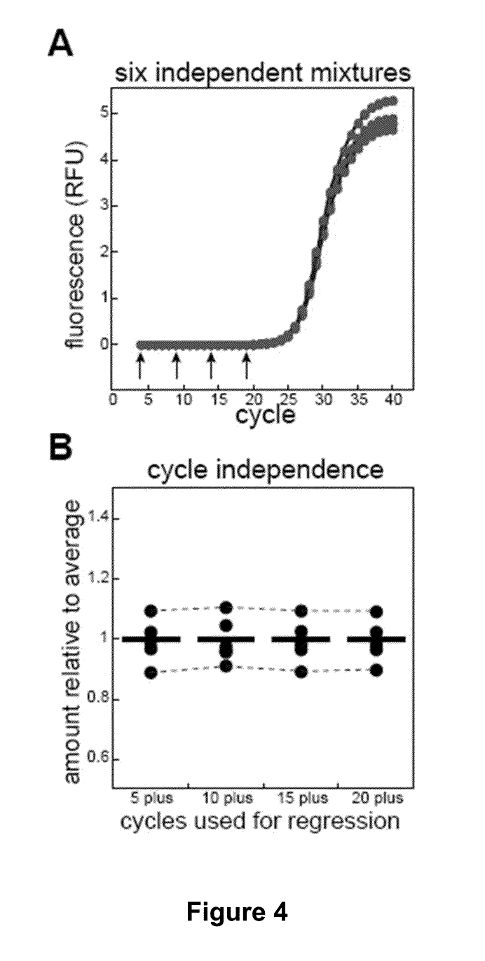

The cycle selected for regression analysis does not significantly alter the resulting quantification because all reactions for a particular target scale fractionally in relation to their relative abundances with unique max and K_{d} values governing the efficiencies in each PCR cycle. However, by selecting a cycle from the baseline region, before the detectable appearance of the product, a more intuitive relationship between data sets is obtained because the influence of max and K_{d} is still minimal. To illustrate these points, relative abundance for a set of six independently-mixed qPCR reactions that amplified the same target from the same cDNA were calculated (FIG. 4). Seed values in cycles 4, 9, 14, and 19 that gave rise to the best fit to the experimental data were then used to calculate abundance relative to the mean (FIG. 4B). The first two data points were not included in calculations because they were observed to vary substantially from the baseline. Additionally, the starting material was not able to be exponentially amplified because only one strand of the target DNA was present in the cDNA mixtures and the first cycle or two would be needed to convert that DNA into suitable double-stranded templates.

A standard deviation from the average of 7.7% was calculated for the whole set of six reactions, which, considering the fact that these mixes were highly viscous and each sample was mixed independently, is quite small for qPCR analysis. Each individual reaction exhibited only small variations in the calculated amounts when different cycles were used for the regression analysis (for example, in FIG. 2(B), dotted lines connect the calculated amounts from the two outliers). The average standard deviation in each sample as a function of the cycle chosen for quantification was ˜0.9%, approximately the limit of pipetting accuracy. Therefore, the seed cycle chosen for the quantification does not matter to any appreciable degree.

When the ability of PCR Equation (6) to fit a variety of experimental data was evaluated, the values of max and K_{d} were independent of the amount of baseline region that was included in the fitting procedure used to obtain them. Appreciable fitting error (R²<0.95) was only introduced when the entire baseline and approximately a third of the above-baseline amplification profile was omitted. Small baseline adjustment errors substantially affect conventional cycle-threshold analysis and can give rise to impossible efficiency terms (FIG. 6). The analysis using global fitting is practically unaffected by baseline errors or signal loss (FIG. 7). Therefore, in principle, any arbitrarily chosen cycle in the baseline can be used to calculate abundance. Relative abundance can be determined between samples as long as the same cycle is chosen for seeding during each analysis.

Quantification Using Global Fitting is not Affected by Reaction Efficiency or Target Abundance

Common methods to compare relative input abundance rely on an accurate estimation of reaction efficiency. In a model, the reaction efficiency changes during each cycle and it is not necessary to extract it because its influence becomes incorporated in the values of max and K_{d}. The efficiency was computationally forced to lower values by altering Equation (6) such that it contained numbers less than one as the first term in the efficiency component (so the sum could not be 2 in any cycle). When the resulting equations were fit to real data, there were noticeable deviations in the fits and reductions in the R value were apparent when this term was 0.98 or less (fitting failed when the value dropped below 0.3. Each forced reduction in the efficiency term was met with changes to both max and K_{d} in the resulting best fit, with dramatically increasing K_{d} values when the term dropped below 0.9. Thus, the choice of one as the first term in the efficiency component of Equation (6) is optimal for describing real data.

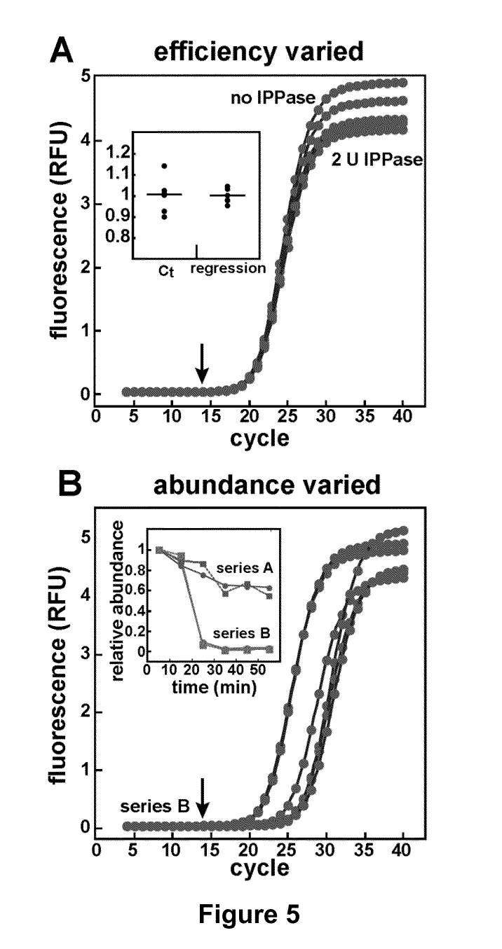

As an additional test of the influence of reaction efficiency on quantification by the disclosed method, deliberate alteration of PCR reaction efficiencies of the same target mixture. Literature reports of increased PCR yield when a thermostable inorganic pyrophosphatase (IPPase) was included in the reactions inspired us to test this enzyme in a qPCR series to see if the reaction could be driven forward by degrading the pyrophosphate, one of the two products of the chain reaction (Kim et al., 2008; Park et al., 2010). Unexpectedly, the addition of IPPase reduced the apparent reaction yield (FIG. 5(A)). This reduction in apparent yield was also observed when different targets were amplified. The cause of the reduction was not known, but it is possible that this version of IPPase (purchased from a commercial source) either directly inhibited the reaction or the preparation contained an inhibitory ingredient that was not listed as a buffer component. Alternatively, the release of free phosphate could have impeded the reaction, lowered the binding affinity of the fluorescent reporter, or reduced the fluorescence efficiency. Nonetheless, the addition of the IPPase induced noticeable perturbations to apparent reaction efficiencies that were reflected as changes to both max and K_{d}. The resulting changes to the profile shapes did not appreciably influence the accuracy of the quantification by the disclosed regression method, but did reduce the accuracy of quantification using the common cycle-threshold (Cₜ) method and mass action method (FIG. 5(A), inset) (Ruijter et al., 2009; Boggy et al., 2010).

Another test of the analysis method was performed to assess the influence of target abundance on the resulting quantification. When serial dilutions of test samples are made (as is common for qPCR interrogations), all competing/influential factors are concomitantly diluted as well, which does not reflect an experimental situation. Real-world sample analysis rarely requires the 100,000-fold dynamic range that is accomplished by the typical application of five 10-fold dilutions, which themselves amplify pipetting variance. Additionally, the baseline length before the visible profile does not influence the calculation. Analysis of data from real samples that had a cDNA amount changing while the rest of the cDNA library remained essentially constant was sought.

A dramatic decrease in the amount of mRNA encoding glyceraldehyde phosphate dehydrogenase in E. coli (encoded by gapA) was observed, in some cases to levels that were less than a twentieth ( 1/20^{th}) of the normal amount present in a control. Because this change in message abundance was representative of what can be encountered in an analysis of transcript abundance, a single, non-averaged qPCR data set of 12 reactions from 12 cDNA libraries was analyzed and compared the resulting template abundances using either the Cₜ method or the global-fitting, regression method (FIG. 5(B)). The output data were similar in scale, but the values from the cycle-threshold method were noisier in comparison the regression method. Also, unlike the regression method, the noise observed using the Cₜ method became more exaggerated in the comparison of samples that had large displacements in their amplification profiles. This phenomenon stems from the use of a power operation to determine relative abundances using C_{q} values of log-transformed data, which exponentially amplified error.

In most cases, the regression method presented herein should not change the conclusions stemming from other popular analysis methods. However, the regression method presented herein reduces the scatter in the data sets and reduces the number of required measurements. Overall, modeling of a PCR reaction allows for the fitting of unmodified amplification profiles using two terms that represent processes having the most influence on reaction efficiency at each cycle. The modeling presented herein revealed that PCR reactions do not stop solely from reagent depletion, which is a commonly held assumption. This approach removes an enigmatic “black box” from qPCR analysis that should aid in teaching and training, it allows accurate quantification that takes advantage of all data in an amplification profile, and it is insensitive to errors in baseline assignment, dynamic signal quality, and reaction efficiency.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining a maximum capacity of reaction based on first data;
determining an apparent affinity of accumulated reaction inhibitors based on the first data;
generating a second data based upon one or more of the determined capacity of reaction and the determined apparent affinity of accumulated reaction inhibitors; and
determining a seed based upon one or more of the first data and the second data.

2. The method of claim 1, further comprising applying a weighting factor to the first data prior to determining one or more of the determined capacity of reaction and the determined apparent affinity of accumulated reaction inhibitors.

3. The method of claim 1, wherein the second data is generated by applying the formula, yield=prev×(1+((max−prev)/max)−(prev/(Kd+prev))), wherein yield is a data point of the second data, max is maximum capacity of reaction, Kd is apparent affinity of accumulated reaction inhibitors, and prev is an amount of template present after a cycle.

4. The method of claim 1, wherein the second data is generated by substantially fitting the formula yield=prev×(1+((max−prev)/max)−(prev/(Kd+prev))) to the first data, wherein yield is a data point of the second data, max is maximum capacity of reaction, Kd is apparent affinity of accumulated reaction inhibitors, and prev is an amount of template present after a cycle.

5. The method of claim 1, wherein the formula is substantially fitted to the first data using non-linear regression.

6. The method of claim 1, wherein the seed is representative of an amount of template DNA.

7. The method of claim 1, wherein the seed is determined based upon a minimal difference between the first data and the second data.

8. A method comprising:
determining a maximum capacity of reaction based on first data;
determining an apparent affinity of accumulated reaction inhibitors based on the first data;
generating a second data based upon one or more of the determined capacity of reaction and the determined apparent affinity of accumulated reaction inhibitors, wherein the second data comprises a plurality of data points, each of the plurality of data points associated with a cycle;
determining a seed based upon a comparison of the first data and the second data; and
determining a third data using the seed as a baseline cycle.

9. The method of claim 8, further comprising applying a weighting factor to the first data prior to determining one or more of the determined capacity of reaction and the determined apparent affinity of accumulated reaction inhibitors.

10. The method of claim 8, wherein the second data is generated by applying the formula yield=prev×(1+((max−prev)/max)−(prev/(Kd+prev))), wherein yield is a data point of the second data, max is maximum capacity of reaction, Kd is apparent affinity of accumulated reaction inhibitors, and prev is an amount of template present after a cycle.

11. The method of claim 8, wherein the second data is generated by substantially fitting the formula yield=prev×(1+((max−prev)/max)−(prev/(Kd+prev))) to the first data, wherein yield is a data point of the second data, max is maximum capacity of reaction, Kd is apparent affinity of accumulated reaction inhibitors, and prev is an amount of template present after a cycle.

12. The method of claim 8, wherein the formula is substantially fitted to the first data using non-linear regression.

13. The method of claim 8, wherein the seed is representative of an amount of template DNA.

14. The method of claim 8, wherein the seed is determined based upon a minimal difference between the first data and the second data.

15. The method of claim 8, wherein the third data is generated by applying the formula yield=prev×(1+((max−prev)/max)−(prev/(Kd+prev))) to the seed, wherein yield is a data point of the third data, max is maximum capacity of reaction, Kd is apparent affinity of accumulated reaction inhibitors, and prev is an amount of template present after a cycle.

16. A system comprising:
a memory storing a first data;
a processor in communication with the memory, the processor configured to: determine a maximum capacity of reaction based on the first data;
determine an apparent affinity of accumulated reaction inhibitors based on the first data;
generate a second data based upon one or more of the determined capacity of reaction and the determined apparent affinity of accumulated reaction inhibitors
determine a seed based upon one or more of the first data and the second data.

17. The system of claim 16, further comprising applying a weighting factor to the first data prior to determining one or more of the determined capacity of reaction and the determined apparent affinity of accumulated reaction inhibitors.

18. The system of claim 16, wherein the second data is generated by applying the formula yield=prev×(1+((max−prev)/max)−(prev/(Kd+prev))), wherein yield is a data point of the second data, max is maximum capacity of reaction, Kd is apparent affinity of accumulated reaction inhibitors, and prev is an amount of template present after a cycle

19. The system of claim 16, wherein the second data is generated by substantially fitting the formula yield=prev×(1+((max−prev)/max)−(prev/(Kd+prev))) to the first data, wherein yield is a data point of the second data, max is maximum capacity of reaction, Kd is apparent affinity of accumulated reaction inhibitors, and prev is an amount of template present after a cycle

20. The system of claim 16, wherein the seed is determined based upon a minimal difference between the first data and the second data.
